(19) United States
(12) Patent Application Publication
(10) Pub. No.: US 2026/0332480 A1
(43) Pub. Date: Oct. 22, 2026

(54) TERMINAL DEVICE POLICY UPDATE METHOD AND APPARATUS

(71) Applicant: BEIJING XIAOMI MOBILE SOFTWARE CO., LTD., Beijing (CN)

(72) Inventors: Jinhua WU, Beijing (CN); Yang SHEN, Beijing (CN); Jianfeng QI, Beijing (CN)

(21) Appl. No.: 19/114,747

(22) PCT Filed: Sep. 26, 2022
(86) PCT No.: PCT/CN2022/121509

§ 371 Date: Mar. 24, 2025

(51) Int. Cl. H04L 41/0894; H04W 48/16

(52) U.S. Cl. CPC H04L 41/0894; H04W 48/16

(57) ABSTRACT

A method for user equipment (UE) policy update includes obtaining UE status assistance operation indication or information of a UE from an application function (AF); and generating or updating a policy of a service session or a service data flow of the UE in combination with the UE status assistance operation indication or information.

### CROSS-REFERENCE TO RELATED APPLICATION

This application is a U.S. national phase of International Application No. PCT/CN2022/121509, filed Sep. 26, 2022, the entire content of which is incorporated herein by reference.

### TECHNICAL FIELD

The disclosure relates to a field of communication technology, in particular to a method and an apparatus for user equipment (UE) policy update.

### BACKGROUND

Mobile media services, extended reality (XR) services such as cloud augmented reality (AR) or virtual reality (VR), cloud gaming, video-based machine or unmanned aerial vehicle remote control, etc. are expected to contribute increasing traffic to 5th generation mobile communication technology (5G) networks. In addition to audio and video flows, the XR services also involve multimodal data flows, such as biotactile perception data flows. The multimodal data describes the same service or application, and data input by the same device or different devices (sensors). These data may be output to one or more target UEs. The data flows in the multimodal data often have a certain correlation or even a strong correlation, such as the synchronization of audio and video flows, or the synchronization of touch and vision, etc. The data flows of this type of media service, the data flows between each other, and the requirements of these service data flows on network transmission all have some common characteristics. Effective identification and utilization of these characteristics will be more conducive to transmission and control of networks and services, as well as service assurance and user experience.

### SUMMARY

According to a first aspect of embodiments of the disclosure, a method for UE policy update is provided. The method is performed by a policy control function (PCF), and includes:
obtaining UE status assistance operation indication or information of a UE from an application function (AF); and
generating or updating a policy of a service session or a service data flow (SDF) of the UE in combination with the UE status assistance operation indication or information.

According to a second aspect of embodiments of the disclosure, another method for UE policy update is provided. The method is performed by an AF, and includes:
sending UE status assistance operation indication or information of a UE to a PCF;
in which the UE status assistance operation indication or information is used to assist the PCF to generate or update a policy of a service session or a SDF of the UE.

According to a third aspect of embodiments of the disclosure, another method for UE policy update is provided. The method is performed by a UE, and includes:
sending UE status assistance operation indication or information of the UE to an AF;
in which the UE status assistance operation indication or information is used to assist a PCF to generate or update a policy of a service session or a SDF of the UE.

### BRIEF DESCRIPTION OF THE DRAWINGS

In order to clearly illustrate technical solutions of embodiments of the disclosure or background technologies, a description of drawings used in the embodiments of the disclosure or the background technologies is given below.

FIG. 1 is a flowchart of a method for UE policy update provided by an embodiment of the disclosure.

FIG. 2 is a flowchart of a method for UE policy update provided by an embodiment of the disclosure.

FIG. 3 is a flowchart of a method for UE policy update provided by an embodiment of the disclosure.

FIG. 4 is a flowchart of a method for UE policy update provided by an embodiment of the disclosure.

FIG. 5 is a flowchart of a method for UE policy update provided by an embodiment of the disclosure.

FIG. 6 is a flowchart of a method for UE policy update provided by an embodiment of the disclosure.

FIG. 7 is a flowchart of a method for UE policy update provided by an embodiment of the disclosure.

FIG. 8a is a flowchart of QoS update provided by an embodiment of the disclosure.

FIG. 8b is a flowchart of an AF requesting related traffic provided by an embodiment of the disclosure.

FIG. 9 is a schematic diagram of a communication apparatus provided by an embodiment of the disclosure.

FIG. 10 is a schematic diagram of a communication device provided by an embodiment of the disclosure.

### DETAILED DESCRIPTION

Embodiments of the disclosure will be described in detail, examples of which are illustrated in the accompanying drawings, in which the same or similar reference numerals indicate the same or similar elements or elements having the same or similar functions throughout. The embodiments described below with reference to the accompanying drawings are exemplary and are intended to explain the disclosure, but not to be construed as limiting the disclosure. In the description of this disclosure, unless otherwise specified, “/” means “or”. For example, A/B means A or B. Moreover, in this disclosure, “and/or” only describes possible relationships between associated objects, which indicates three kinds of relationships. For example, A and/or B means that A exists alone, A and B both exist, and B exists alone.

The terms used in the disclosure are only for the purpose of describing specific embodiments, and are not intended to limit embodiments of the disclosure. The singular forms of “a” and “the” used in the embodiments and the appended claims of the disclosure are also intended to include plural forms, unless the context clearly indicates other meanings.

It is understandable that although the terms “first”, “second”, and “third” may be used in embodiments of the disclosure to describe various types of information, the information should not be limited to these terms. These terms are only used to distinguish the same type of information from each other. For example, without departing from the scope of the embodiments of the disclosure, the first information may also be referred to as the second information, and similarly, the second information may also be referred to as the first information. Depending on the context, the term “if” and “in case of” as used herein may be interpreted as “when”, “upon” or “in response to determining”.

Embodiments of the disclosure are described in detail below, examples of which are illustrated in the accompanying drawings, in which the same or similar reference numerals refer to the same or similar elements throughout. The embodiments described below with reference to the accompanying drawings are exemplary and are intended to be used to explain the disclosure, but should not be construed as limiting the disclosure.

The existing 5GS uses a general QoS mechanism to handle various types of data services including XR services. It does not fully consider characteristics of XR media services and cannot effectively support differentiated uplink and downlink requirements, such as asymmetric requirements of uplink data reliability and downlink data bandwidth. Meanwhile, XR media data flows have characteristics of high bandwidth, low latency and high reliability, resulting in significant energy consumption. The energy consumption plan is also an important factor affecting service usage and user experience. In the related art, there is still a lack of effective means for UE policy update to achieve trade-off of throughput, delay, reliability and other factors.

The embodiments of the disclosure provides a method and an apparatus for UE policy update, which can be applied to the 5GS and can use UE status assistance operation indication or information to trigger UE policy update, so as to provide corresponding QoS and policy for the UE, thereby achieving the trade-off of throughput, delay, reliability and other factors.

It should be noted that the UE in the embodiment of the disclosure is an entity on a user side for receiving or transmitting signals, such as a cellular phone. The UE may also be referred to as terminal, UE, mobile station (MS), mobile terminal (MT), and the like. The UE can be a car with communication functions, a smart car, a mobile phone, a wearable device, a Pad, a computer with wireless transceiver functions, a virtual reality (VR) UE, an augmented reality (AR) UE, a wireless UE in industrial control, a wireless UE in self-driving, a wireless UE in remote medical surgery, a wireless UE in smart grid, a wireless UE in transportation safety, a wireless UE in smart city, a wireless UE in smart home, etc. The specific technology and specific device form adopted by the UE are not limited in the embodiment of the disclosure.

The method and the apparatus for UE policy update provided by this disclosure will be introduced in detail in combination with the accompanying drawings.

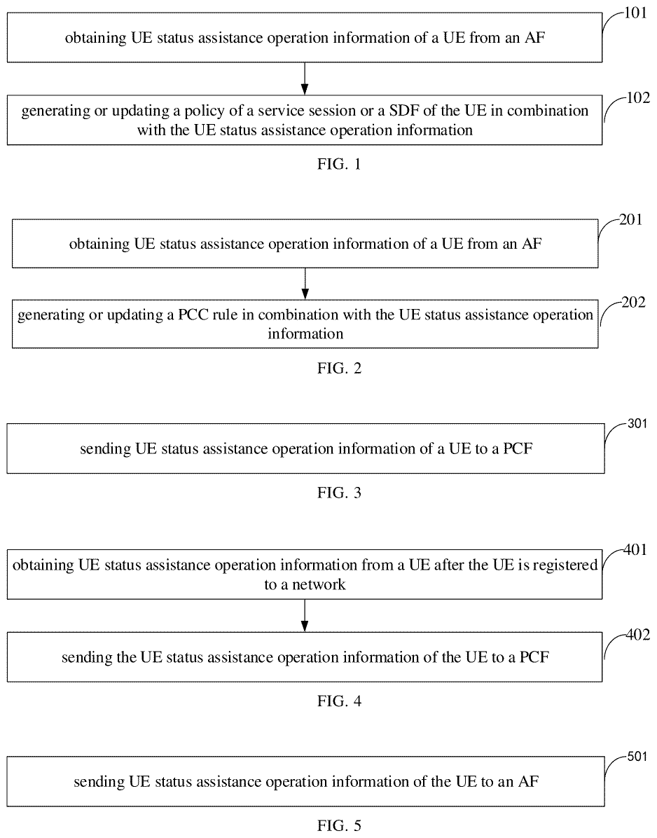

FIG. 1 is a flowchart of a method for UE policy update provided by an embodiment of the disclosure. It should be noted that the method for UE policy update in an embodiment of the disclosure is performed by a PCF (policy control function). As illustrated in FIG. 1, the method includes, but is not limited to, the following steps.

At step 101, UE status assistance operation indication or information of a UE is obtained from an AF (application function).

In an implementation, the UE status assistance operation indication or information may be obtained by the AF from the UE after the UE is registered to a network. Optionally, after the UE is registered to the network, the AF obtains the UE status assistance operation indication or information of the UE from the UE.

Optionally, in some embodiments of the disclosure, the UE status assistance operation indication or information is used to assist the PCF to generate or update a policy of a service session or a SDF of the UE.

At step 102, the policy of the service session or the SDF of the UE is generated or updated in combination with the UE status assistance operation indication or information.

In an implementation, the UE status assistance operation indication or information includes, but is not limited to, at least one of: a UE status assistance operation mode; a UE status assistance operation mode indicator; a threshold value; a UE status assistance operation functionality; a priority; or an importance.

It should be noted that a category of information included in the UE status assistance operation indication or information can be decided according to a practical implementation. Optionally, in an implementation, a category of the UE status assistance operation mode in the UE status assistance operation indication or information is mandatory, and a category of other information in the UE status assistance operation indication or information is optional. That is, in an implementation, the UE status assistance operation indication or information may include the UE status assistance operation mode. Optionally, the UE status assistance operation indication or information may also include other information, for example, including at least one of the UE status assistance operation mode indicator, the threshold value, the UE status assistance operation functionality, the priority or the importance.

In an embodiment of the disclosure, the UE status assistance operation mode is applied for matching traffic and associated parameters. The associated parameters may be, for example, QoS-related parameters.

In an embodiment of the disclosure, the UE status assistance operation mode indicator may be indication information indicating autonomous operation or UE-assistance operation when the UE status assistance operation mode is set to a first mode. The first mode can be any one of: load balancing, power consumption and PDU set based QoS handling. Optionally, the UE status assistance operation mode is set to the first mode, which indicates either autonomous operation or UE-assistance operation.

In an embodiment of the disclosure, the threshold value includes, but is not limited to, at least one of: a maximum round trip time (RTT), a maximum packet loss rate, a GFBR or an AMBR.

In an embodiment of the disclosure, the UE status assistance operation functionality indicates that a first functionality is applied for matching traffic. The first functionality includes any one of a load balancing functionality, a power consumption functionality and a PDU set based QoS handling functionality. Optionally, in an implementation, the UE status assistance operation functionality may indicate any one of the load balancing functionality, the power consumption functionality and the PDU set based QoS handling functionality, which can be applied for matching traffic.

In an embodiment of the disclosure, the priority indicates a priority level of QoS applied for matching traffic.

In an embodiment of the disclosure, the importance indicates an importance level of QoS applied for matching traffic.

In the disclosure, the PCF obtains the UE status assistance operation indication or information from the AF, and takes the UE status assistance operation indication or information as the input of policy decision, which is helpful to generate a PCC rule that better matches the service and the UE status of the UE, so as to achieve trade-off of throughput, latency, reliability and other factors. In addition, the disclosure can avoid exposing the UE status to a network with no need to obtain the UE status from the UE.

It should be noted that in some embodiments of the disclosure, there are many ways for the PCF to obtain the UE status assistance operation indication or information of the UE from the AF. For example, the PCF can obtain the UE status assistance operation indication or information directly from the AF, or from the AF (such as from a third-party AF or an untrusted AF) through the NEF, or from the AF through a TSCTSF (time-sensitive communication time synchronization function) (for example, for a time-sensitive service, when the TSCTSF is triggered, the step of obtaining the UE status assistance operation indication or information is executed). Some implementations for the PCF to obtain the UE status assistance operation indication or information of the UE from the AF are given below.

In a possible implementation, the PCF may directly obtain the UE status assistance operation indication or information of the UE from the AF.

In another possible implementation, the PCF may obtain the UE status assistance operation indication or information from the AF through the NEF.

In another possible implementation, the PCF may obtain the UE status assistance operation indication or information from the AF through the TSCTSF. For example, in a case that a service of the UE is the time-sensitive service, the TSCTSF is triggered. The PCF may obtain the UE status assistance operation indication or information from the AF through the TSCTSF.

In another possible implementation, the PCF may obtain the UE status assistance operation indication or information from the AF through the TSCTSF and the NEF. For example, in a case that the service of the UE is the time-sensitive service, the TSCTSF is triggered. The PCF may obtain the UE status assistance operation indication or information from the AF through the TSCTSF and the NEF.

FIG. 2 is a flowchart of a method for UE policy update provided by an embodiment of the disclosure. It should be noted that the method for UE policy update in an embodiment of the disclosure is performed by a PCF. As illustrated in FIG. 2, the method includes but is not limited to the following steps.

At step 201, UE status assistance operation indication or information of a UE is obtained from an AF.

In an embodiment of the disclosure, step 201 may be realized by any implementation in embodiments of the disclosure, which is not limited in the embodiments of the disclosure and will not be repeated herein.

At step 202, a PCC rule is generated or updated in combination with the UE status assistance operation indication or information.

Optionally, in some embodiments of the disclosure, generating or updating the PCC rule may include: updating a QoS parameter of a service session or a SDF of the UE. As an example, the service may be an XRM service, and the SDF may be multimodal data.

In an embodiment of the disclosure, the QoS parameter includes at least one of:
an uplink GBR (guaranteed bit rate) traffic bit rate;
a downlink GBR traffic bit rate;
an uplink non-GBR traffic bit rate;
a downlink non-GBR traffic bit rate;
a maximum RTT; or
a maximum packet loss rate.

Optionally, in an embodiment of the disclosure, an implementation of updating the QoS parameter of the service session or the SDF of the UE may include performing GFBR update on the GBR traffic. As an example, updating the GFBR may include lowering or raising the GFBG.

In other embodiments of the disclosure, an implementation of updating the QoS parameter of the service session or the SDF of the UE may include: performing AMBR-related updating on the non-GBR traffic. As an example, performing the AMBR-related updating may include lowering or raising the AMBR. There are three levels for updating the AMBR, i.e., UE-AMBR, Session-AMBR, and UE-Slice-AMBR. The UE-Slice-AMBR updating may include a GBR traffic and a non-GBR traffic.

In other embodiments of the disclosure, the UE status assistance operation mode is not only applied for matching traffic, but also applied for matching other scenarios, for example, also applied for matching: data packet, PDU set, QoS flow, UE slice, UE, all UEs of XRM service group and other different granularities.

Optionally, in some embodiments of the disclosure, an implementation of generating or updating the PCC rule includes: making a decision on whether to perform PDU set-based QoS handling; and/or, making a decision on whether to select different QoS profiles for different QoS levels based on first information of a PDU set or a PDU set group, in which the first information includes at least one of a priority, an importance or a dependency.

It should be noted that the method of the embodiment of the disclosure may be applied to a single-PCF scenario or a multi-PCF scenario. Optionally, in a case where the method of the embodiment of the disclosure is applicable for the multi-PCF scenario, the method of the embodiment of the disclosure may further include: triggering other PCFs in the multi-PCF scenario to perform QoS change; or, after storing the UE status assistance operation indication or information in a UDM or a UDR, triggering a subscription to one of the UDM, the UDR and a NEF to send the UE status assistance operation indication or information to a corresponding PCF.

For example, for the multi-PCF scenario, a single PCF may directly trigger other PCFs to perform the QoS change. Optionally, for the multi-PCF scenario, the PCF, as an execution subject of the method in the embodiment of the disclosure belongs to one of the PCFs in the multi-PCF scenario. After the one PCF performs update, the PCF may trigger other PCFs to perform the QoS change. That is, when a plurality of PCFs, one PCF may trigger other PCF to perform update after one PCF performs update.

For another example, for the multi-PCF scenario, after the PCF, i.e., an execution subject of the method in the embodiment of the disclosure, stores the UE status assistance operation indication or information to the UDM or the UDR, the PCF as the execution subject triggers the subscription to one of the UDM, the UDR and the NEF to report the UE status assistance operation indication or information to the corresponding PCF. The corresponding PCF may perform the step of obtaining the UE status assistance operation indication or information, or directly performing XMR service group policy change.

By implementing the embodiment of the disclosure, it may be helpful to generate the PCC rule that better matches the service and the UE status of the UE, so as to achieve trade-off of throughput, delay, reliability and other factors. In addition, the disclosure can avoid exposing the UE status to a network with no need to obtain the UE status from the UE.

FIG. 3 is a flowchart of a method for UE policy update provided by an embodiment of the disclosure. It should be noted that the method for UE policy update in the embodiment of the disclosure is performed by an AF. As illustrated in FIG. 3, the method may include but is not limited to the following steps.

At step 301, UE status assistance operation indication or information of a UE is sent to a PCF.

In an embodiment of the disclosure, the UE status assistance operation indication or information is used to assist the PCF to generate or update a policy of a service session or a SDF of the UE.

It should be noted that in some embodiments of the disclosure, an implementation of sending the UE status assistance operation indication or information of the UE to the PCF may include sending the UE status assistance operation indication or information directly to the PCF.

In some embodiments of the disclosure, an implementation of sending the UE status assistance operation indication or information of the UE to the PCF may include sending the UE status assistance operation indication or information to the PCF through a NEF.

In some embodiments of the disclosure, the implementation of sending the UE status assistance operation indication or information of the UE to the PCF may include: sending the UE status assistance operation indication or information to the PCF through a TSCTSF; or, sending the UE status assistance operation indication or information to the PCF through the TSCTSF or a NEF.

In an implementation, the UE status assistance operation indication or information includes but is not limited to at least one of: a UE status assistance operation mode; a UE status assistance operation mode indicator; a threshold value; a UE status assistance operation functionality; a priority; or an importance.

It should be noted that a category of information included in the UE status assistance operation indication or information may be decided according to a practical implementation. Optionally, in an implementation, a category of the UE status assistance operation mode in the UE status assistance operation indication or information is mandatory, and a category of other information in the UE status assistance operation indication or information is optional. That is, in an implementation, the UE status assistance operation indication or information may include the UE status assistance operation mode. Optionally, the UE status assistance operation indication or information may also include other information, for example, including at least one of the UE status assistance operation mode indicator, the threshold value, the UE status assistance operation functionality, the priority or the importance.

In an embodiment of the disclosure, the UE status assistance operation mode is applied for matching traffic and associated parameters.

In an embodiment of the disclosure, the UE status assistance operation mode indicator is indication information indicating autonomous operation or UE-assistance operation when the UE status assistance operation mode is set to a first mode. The first mode is any one of: load balancing; power consumption; and PDU set based QoS handling. Optionally, in a case that the UE status assistance operation mode is set to the first mode, it indicates that the mode is either autonomous operation or UE-assistance operation.

In an embodiment of the disclosure, the threshold value includes but is not limited to at least one of: a maximum RTT; a maximum packet loss rate; a GFBR; or an AMBR.

In the embodiment of the disclosure, the UE status assistance operation functionality indicates that a first functionality is applied for matching traffic. The first functionality includes any one of a load balancing functionality, a power consumption functionality and a PDU set based QoS handling functionality. Optionally, in an implementation, the UE status assistance operation functionality may indicate that any one of the load balancing functionality, the power consumption functionality and the PDU set based QoS handling functionality, which can be applied for matching traffic.

In an embodiment of the disclosure, the priority indicates a priority level of QoS applied for matching traffic.

In an embodiment of the disclosure, the importance indicates an importance level of QoS applied for matching traffic.

By implementing the embodiment of the disclosure, the AF sends the UE status assistance operation indication or information of the UE to the PCF, which is helpful to assist the PCF to generate or update the policy of the service session or the SDF of the UE, and is helpful to generate the PCC rule that better matches the service and UE status of the UE, thus achieving trade-off of throughput, delay, reliability and other factors.

FIG. 4 is a flowchart of a method for UE policy update provided by an embodiment of the disclosure. It should be noted that the method for UE policy update in the embodiment of the disclosure is performed by an AF. As illustrated in FIG. 4, the method may include but is not limited to the following steps.

At step 401, UE status assistance operation indication or information is obtained from a UE after the UE is registered to a network.

Optionally, the AF obtains the UE status assistance operation indication or information from the UE after the UE is registered to the network.

At step 402, the UE status assistance operation indication or information of the UE is sent to a PCF, in which the UE status assistance operation indication or information is used to assist the PCF to generate or update a policy of a service session or a SDF of the UE.

In an embodiment of the disclosure, step 402 may be realized by any implementation of embodiments of the disclosure, which is not limited in the embodiment of the disclosure and will not be repeated here.

By implementing the embodiment of the disclosure, the AF sends the UE status assistance operation indication or information of the UE to the PCF, to assist the PCF in generating or updating the policy of the service session or the SDF of the UE, which is helpful to generate the PCC rule that better matches the service and the UE status of the UE, thereby achieving trade-off of throughput, delay, reliability and other factors. In addition, the disclosure can avoid exposing the UE status to a network with no need to obtain the UE status from the UE.

FIG. 5 is a flowchart of a method for UE policy update provided by an embodiment of the disclosure. It should be noted that the method for UE policy update in the embodiment of the disclosure is performed by a UE. As illustrated in FIG. 5, the method may include but is not limited to the following steps.

At step 501, UE status assistance operation indication or information of the UE is sent to an AF.

In an embodiment of the disclosure, the UE status assistance operation indication or information is used to assist a PCF to generate or update a policy of a service session or a SDF of the UE.

Optionally, the UE sends the UE status assistance operation indication or information of the UE to the AF. The AF sends the UE status assistance operation indication or information to the PCF. The PCF obtains the UE status assistance operation indication or information from the AF, and generates or updates the policy of the service session or the SDF of the UE in combination with the UE status assistance operation indication or information.

In an implementation, the UE status assistance operation indication or information may include, but is not limited to, at least one of: a UE status assistance operation mode; a UE status assistance operation mode indicator; a threshold value; a UE status assistance operation functionality; a priority; or an importance.

It should be noted that a category of information included in the UE status assistance operation indication or information may be decided according to a practical implementation. Optionally, in an implementation, a category of the UE status assistance operation mode in the UE status assistance operation indication or information is mandatory, and a category of other information in the UE status assistance operation indication or information is optional. That is, in an implementation, the UE status assistance operation indication or information may include the UE status assistance operation mode. Optionally, the UE status assistance operation indication or information may also include other information, for example, including at least one of the UE status assistance operation mode indicator, the threshold value, the UE status assistance operation functionality, the priority or the importance.

In an embodiment of the disclosure, the UE status assistance operation mode is applied for matching traffic and associated parameters.

In an embodiment of the disclosure, the UE status assistance operation mode indicator is indication information indicating autonomous operation or UE-assistance operation when the UE status assistance operation mode is set to a first mode. The first mode is any one of: load balancing; power consumption; and PDU set based QoS handling. Optionally, in a case where the UE status assistance operation mode is set to the first mode, it indicates that the mode is either autonomous operation or UE-assistance operation.

In an embodiment of the disclosure, the threshold value includes but is not limited to at least one of: a maximum RTT; a maximum packet loss rate; a GFBR; or an AMBR.

In the embodiment of the disclosure, the UE status assistance operation functionality indicates that a first functionality is applied for matching traffic. The first functionality includes any one of a load balancing functionality, a power consumption functionality and a PDU set based QoS handling functionality. Optionally, in an implementation, the UE status assistance operation functionality may indicate that any one of the load balancing functionality, the power consumption functionality and the PDU set based QoS handling functionality which can be applied for matching traffic.

In an embodiment of the disclosure, the priority indicates a priority level of QoS applied for matching traffic.

In an embodiment of the disclosure, the importance indicates an importance level of QoS applied for matching traffic.

By implementing the embodiment of the disclosure, the UE sends the UE status assistance operation indication or information to the AF, so that the PCF may obtain the UE status assistance operation indication or information from the AF, and generates or updates the policy of the service session or the SDF of the UE in combination with the UE status assistance operation indication or information, to achieve trade-off of throughput, delay, reliability and other factors.

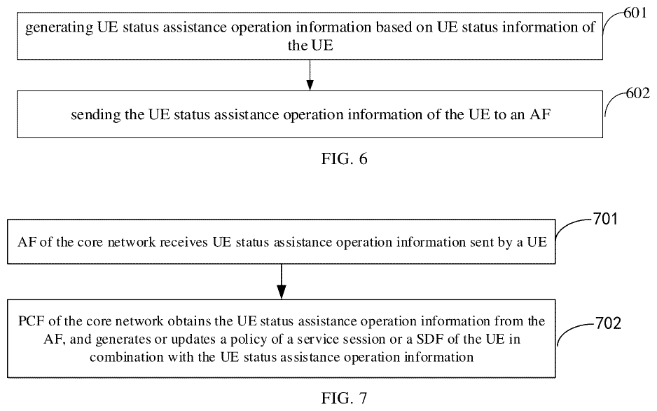

FIG. 6 is a flowchart of a method for UE policy update provided by an embodiment of the disclosure. It should be noted that the method for UE policy update in the embodiment of the disclosure is performed by a UE. As illustrated in FIG. 6, the method may include but is not limited to the following steps.

At step 601, UE status assistance operation indication or information is generated based on UE status information of the UE.

In an embodiment of the disclosure, the UE status information includes but is not limited to at least one of: a battery level; a battery life; a powered mode; an overheating status; or a load status.

In some embodiments of the disclosure, taking the UE status assistance operation indication or information including the UE status assistance operation mode indicator as an example, optionally, the UE may generate the UE status assistance operation mode indicator based on the UE status information. For example, in a case where the UE status assistance operation mode is set to a first mode, it indicates either autonomous operation or UE-assistance operation. The first mode is any one of: load balancing; power consumption; PDU set based QoS handling.

Optionally, the UE status assistance operation indication or information generated by the UE according to the UE status information may be used to indicate relevant information of policy-related rule to be obtained by the UE.

In some embodiments, the UE status assistance operation indication or information includes at least one of:
a UE status assistance operation indicator;
UE status assistance operation requirement information; or
UE status assistance operation decision information.

In an embodiment of the disclosure, the UE generating the UE status assistance operation indication or information according to the UE status information may include generating the UE status assistance operation indicator.

In an embodiment of the disclosure, the UE generating the UE status assistance operation indication or information according to the UE status information may include generating the UE status assistance operation requirement information.

It is understood that the generated UE status assistance operation requirement information may be that the UE expects the network to configure a decision-related rule for the UE that meets the UE status assistance operation requirement information of the UE.

In an embodiment of the disclosure, the UE generating the UE status assistance operation indication or information according to the UE status information may include generating the UE status assistance operation decision information.

It is understood that the generated UE status assistance operation decision information may be assistance operation decision information that the UE expects to be configured by the network.

It should be noted that the above embodiments are not exhaustive, and are only schematic examples of some embodiments. The above embodiments can be implemented alone or implemented together with other embodiments. The above embodiments are only schematic examples, not as specific limitations on the scope of protection of the embodiments of the disclosure.

In the embodiment of the disclosure, the UE generates the UE status assistance operation indication or information according to the UE status information. The UE status assistance operation indication or information can be used to indicate information as shown in the following Table 1.

TABLE 1

| Information name | Description |
|---|---|
| UE status | Identifies the UE status Assistance Operation mode |
| Assistance | that should be applied for the matching traffic and |
| Operation Mode | associated parameters. |
| UE status | Indicates either autonomous operation or UE- |
| Assistance | assistance operation if UE status Assistance Operation |
| Operation Mode | mode is set to e.g. “Load Balancing”/“power |
| Indicator | consumption”/“PDU set based QoS handling”. |
| Threshold Values | A Maximum RTT and/or a Maximum Packet Loss |
| | Rate, and/or GFBR/AMBR |
| UE status | Identifies whether the “Load Balancing” functionality/ |
| Assistance | “power consumption” functionality/“PDU set based |
| Operation | QoS handling” functionality should be applied for the |
| Functionality | matching traffic. |
| Priority/ | Identifies whether the QoS should be applied the high |
| importance | priority/importance level for the matching traffic. |

It is understood that each element in Table 1 above exists independently, and these elements are listed in the same table by way of example, but it does not mean that all the elements in the table must exist at the same time as shown in the table. The value of each element is independent of any other element value in Table 1. Therefore, it is understood by those skilled in the art that a value of each element in Table 1 is an independent embodiment. It should be noted that the embodiments of the disclosure include a plurality of tables, and each table is similar to Table 1, which combines a plurality of independent embodiments in the same table, and each element in these tables should also be regarded as an independent embodiment.

In some embodiments, the UE status assistance operation indication or information is configured to indicate at least one of following information:
a UE status assistance operation mode;
a UE status assistance operation mode indicator;
a threshold value;
a UE status assistance operation functionality;
a priority level; or
an importance level.

In the embodiment of the disclosure, the UE generates the UE status assistance operation indication or information according to the UE status information, and the UE status assistance operation indication or information may indicate the assistance operation mode.

In the embodiment of the disclosure, the UE generates the UE status assistance operation indication or information according to the UE status information, and the UE status assistance operation indication or information may indicate the operation instruction corresponding to the assistance operation mode.

In the embodiment of the disclosure, the UE generates the UE status assistance operation indication or information according to the UE status information, and the UE status assistance operation indication or information may indicate the threshold value.

In the embodiment of the disclosure, the UE generates the UE status assistance operation indication or information according to the UE status information, and the UE status assistance operation indication or information may indicate the assistance operation functionality.

In the embodiment of the disclosure, the UE generates the UE status assistance operation indication or information according to the UE status information, and the UE status assistance operation indication or information may indicate the priority level.

In the embodiment of the disclosure, the UE generates the UE status assistance operation indication or information according to the UE status information, and the UE status assistance operation indication or information may indicate the importance level.

It should be noted that the above embodiments are not exhaustive, and they are schematic representations of some embodiments. The above embodiments can be implemented alone or implemented together with other embodiments. The above embodiments are only schematic representations, not as specific limitations on the protection scope of the embodiments of the disclosure.

In some embodiments, the assistance operation mode is applied for matching traffic and associated parameters.

In an embodiment of the disclosure, the UE generates the UE status assistance operation indication or information according to the UE status information, and the UE status assistance operation indication or information may indicates the assistance operation mode. The assistance operation mode is applied for matching traffic and associated parameters.

It should be noted that the assistance operation mode may also be applied for matching one or more of a packet, a PDU set, a QoS flow, a PDU session, a UE slice, a UE, all UEs of XRM service group, etc.

In some embodiments, the operation instruction corresponding to the assistance operation mode indicates at least one of:
autonomous operation when the assistance operation mode is set to load balancing;
UE-assistance operation when the assistance operation mode is set to load balancing;
autonomous operation when the assistance operation mode is set to power consumption;
UE-assistance operation when the assistance operation mode is set to power consumption;
autonomous operation when the assistance operation mode is set to PDU set based QoS handling; or
UE-assistance operation when the assistance operation mode is set to PDU set based QoS handling.

In an embodiment of the disclosure, the UE generates the UE status assistance operation indication or information according to the UE status information. The UE status assistance operation indication or information may be used to indicate the operation instruction corresponding to the assistance operation mode. The operation instruction corresponding to the assistance operation mode may indicate the autonomous operation when the assistance operation mode is set to the load balancing.

In an embodiment of the disclosure, the UE generates the UE status assistance operation indication or information according to the UE status information. The UE status assistance operation indication or information may be used to indicate the operation instruction corresponding to the assistance operation mode. The operation instruction corresponding to the assistance operation mode may indicate the UE-assistance operation when the assistance operation mode is set to the load balancing.

In an embodiment of the disclosure, the UE generates the UE status assistance operation indication or information according to the UE status information. The UE status assistance operation indication or information may be used to indicate the operation instruction corresponding to the assistance operation mode. The operation instruction corresponding to the assistance operation mode may indicate the autonomous operation when the assistance operation mode is set to the power consumption.

In an embodiment of the disclosure, the UE generates the UE status assistance operation indication or information according to the UE status information. The UE status assistance operation indication or information may be used to indicate the operation instruction corresponding to the assistance operation mode. The operation instruction corresponding to the assistance operation mode may indicate the UE-assistance operation when the assistance operation mode is set to the power consumption.

In an embodiment of the disclosure, the UE generates the UE status assistance operation indication or information according to the UE status information. The UE status assistance operation indication or information may be used to indicate the operation instruction corresponding to the assistance operation mode. The operation instruction corresponding to the assistance operation mode may indicate the autonomous operation when the assistance operation mode is set to PDU set based QoS handling.

In an embodiment of the disclosure, the UE generates the UE status assistance operation indication or information according to the UE status information. The UE status assistance operation indication or information can be used to indicate the operation instruction corresponding to the assistance operation mode. The operation instruction corresponding to the assistance operation mode may indicate UE-assistance operation when the assistance operation mode is set to the PDU set based QoS handling.

It should be noted that the above embodiments are not exhaustive, and they are schematic representations of some embodiments. The above embodiments can be implemented alone or implemented together with other embodiments. The above embodiments are only schematic representations, not as specific limitations on the protection scope of the embodiments of the disclosure.

In some embodiments, the threshold value includes at least one of:
a maximum RTT;
a maximum packet loss rate;
a GFBR; or
an AMBR.

In an embodiment of the disclosure, the UE generates the UE status assistance operation indication or information according to the UE status information. The UE status assistance operation indication or information may indicate the threshold value, which may include a RTT (i.e., the maximum RTT).

In an embodiment of the disclosure, the UE generates the UE status assistance operation indication or information according to the UE status information. The UE status assistance operation indication or information may indicate the threshold value, which may include the maximum packet loss rate.

In an embodiment of the disclosure, the UE generates the UE status assistance operation indication or information according to the UE status information. The UE status assistance operation indication or information may indicate a threshold value, which may include a GFBR.

In an embodiment of the disclosure, the UE generates the UE status assistance operation indication or information according to the UE status information. The UE status assistance operation indication or information may indicate a threshold value, which may include the AMBR.

It should be noted that the above embodiments are not exhaustive, and they are schematic representations of some embodiments. The above embodiments can be implemented alone or implemented together with other embodiments. The above embodiments are only schematic representations, not as specific limitations on the protection scope of the embodiments of the disclosure.

In some embodiments, the assistance operation mode functionality includes at least one of:
applying a load balancing functionality for matching traffic;
cancelling to apply the load balancing functionality for matching traffic;
applying a power consumption functionality for matching traffic;
cancelling to apply the power consumption functionality for matching traffic;
applying a PDU set based QoS handling functionality for matching traffic;
cancelling to apply the PDU set based QoS handling functionality for matching traffic.

In an embodiment of the disclosure, the UE generates the UE status assistance operation indication or information according to the UE status information. The UE status assistance operation indication or information may be used to indicate the assistance operation mode functionality. The assistance operation mode functionality may indicate applying the load balancing functionality for matching traffic.

In an embodiment of the disclosure, the UE generates the UE status assistance operation indication or information according to the UE status information. The UE status assistance operation indication or information may be used to indicate the assistance operation mode functionality. The assistance operation mode functionality may indicate cancelling to apply the load balancing functionality for matching traffic.

In an embodiment of the disclosure, the UE generates the UE status assistance operation indication or information according to the UE status information. The UE status assistance operation indication or information may be used to indicate the assistance operation mode functionality. The assistance operation mode functionality may indicate applying the power consumption functionality for matching traffic.

In an embodiment of the disclosure, the UE generates the UE status assistance operation indication or information according to the UE status information. The UE status assistance operation indication or information may be used to indicate the assistance operation mode functionality. The assistance operation mode functionality may indicate cancelling to apply the power consumption functionality for matching traffic.

In the embodiment of the disclosure, the UE generates the UE status assistance operation indication or information according to the UE status information. The UE status assistance operation indication or information may be used to indicate the assistance operation mode functionality. The assistance operation mode functionality may indicate applying the PDU set based QoS handling for matching traffic.

In the embodiment of the disclosure, the UE generates the UE status assistance operation indication or information according to the UE status information. The UE status assistance operation indication or information may be used to indicate the assistance operation mode functionality. The assistance operation mode functionality may indicate cancelling to apply the PDU set based QoS handling for matching traffic.

It should be noted that the above embodiments are not exhaustive, and they are schematic representations of some embodiments. The above embodiments can be implemented alone or implemented together with other embodiments. The above embodiments are only schematic representations, not as specific limitations on the protection scope of the embodiments of the disclosure.

In some embodiments, the priority level indicates a priority level of a QoS rule applied for matching traffic.

In an embodiment of the disclosure, the UE generates the UE status assistance operation indication or information according to the UE status information. The UE status assistance operation indication or information may be used to indicate the priority level. The priority level indicates the priority level of the QoS level applied for matching traffic.

In some embodiments, the importance indicates an importance level of a QoS rule applied for matching traffic.

In an embodiment of the disclosure, the UE generates the UE status assistance operation indication or information according to the UE status information. The UE status assistance operation indication or information may be used to indicate the importance level. The importance level indicates the importance level of the QoS rule applied for matching traffic.

At step 602, the UE status assistance operation indication or information of the UE is sent to an AF.

In an embodiment of the disclosure, the UE status assistance operation indication or information is used to assist a PCF to generate or update a policy of a service session or a SDF of the UE.

In an embodiment of the disclosure, step 602 can be realized in any implementation of the embodiments of the disclosure, which is not limited in the embodiments of the disclosure and will not be repeated here.

By implementing the embodiment of the disclosure, the UE sends the UE status assistance operation indication or information to the AF, so that the PCF may obtain the UE status assistance operation indication or information from the AF, and generate or update the policy of the service session or the SDF of the UE in combination with the UE status assistance operation indication or information, so as to achieve trade-off of throughput, latency, reliability and other factors. In addition, the UE does not need to report the UE status to the network side, which can avoid exposing the UE status to the network.

FIG. 7 is a flowchart of a method for UE policy update provided by an embodiment of the disclosure. It should be noted that this method is performed by a core network. As illustrated in FIG. 7, the method may include but is not limited to the following steps.

At step 701, an AF of the core network receives UE status assistance operation indication or information sent by a UE.

At step 702, a PCF of the core network obtains the UE status assistance operation indication or information from the AF, and generates or updates a policy of a service session or a SDF of the UE in combination with the UE status assistance operation indication or information.

In an implementation, the PCF of the core network directly obtains the UE status assistance operation indication or information from the AF.

In another implementation, the PCF of the core network obtains the UE status assistance operation indication or information from the AF through a NEF.

In another implementation, the PCF of the core network obtains the UE status assistance operation indication or information from the AF through a TSCTSF.

In another implementation, the PCF of the core network obtains the UE status assistance operation indication or information from the AF through the TSCTSF and the NEF.

In some embodiments of the disclosure, the PCF of the core network generates or updates a rule in combination with the UE status assistance operation indication or information.

In an implementation, generating or updating the PCC rule includes: updating a QoS parameter of the service session or the SDF of the UE.

The QoS parameter includes at least one of: an uplink GBR traffic bit rate; a downlink GBR traffic bit rate; an uplink non-GBR traffic bit rate; a downlink non-GBR traffic bit rate; a maximum RTT; or a maximum packet loss rate.

In another implementation, generating or updating the PCC rule includes: making a decision on whether to perform PDU set-based QoS handling; and/or, making a decision on whether to select different QoS profiles for different QoS levels based on first information of a PDU set or a PDU set group, in which the first information includes at least one of a priority, an importance or a dependency.

In an implementation, the UE status assistance operation indication or information includes at least one of: a UE status assistance operation mode; a UE status assistance operation mode indicator; a threshold value; a UE status assistance operation functionality; a priority; or an importance.

In a possible implementation, the UE status assistance operation mode is applied for matching traffic and associated parameters.

In a possible implementation, the UE status assistance operation mode indicator is indication information indicating autonomous operation or UE-assistance operation when the UE status assistance operation mode is set to a first mode, in which the first mode is any one of: load balancing; power consumption; and PDU set based QoS handling.

In a possible implementation, the threshold value includes at least one of: a maximum RTT; a maximum packet loss rate; a GFBR; or an AMBR.

In a possible implementation, the UE status assistance operation functionality indicates that a first functionality is applied for matching traffic, in which the first functionality includes any one of a load balancing functionality, a power consumption functionality and a PDU set based QoS handling functionality.

In a possible implementation, the priority indicates a priority level of QoS applied for matching traffic.

In a possible implementation, the importance indicates an importance level of QoS applied for matching traffic.

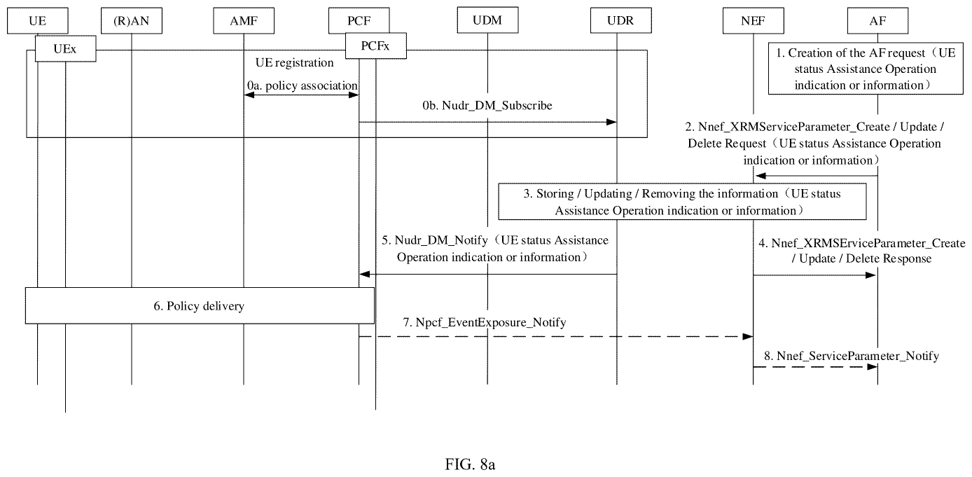

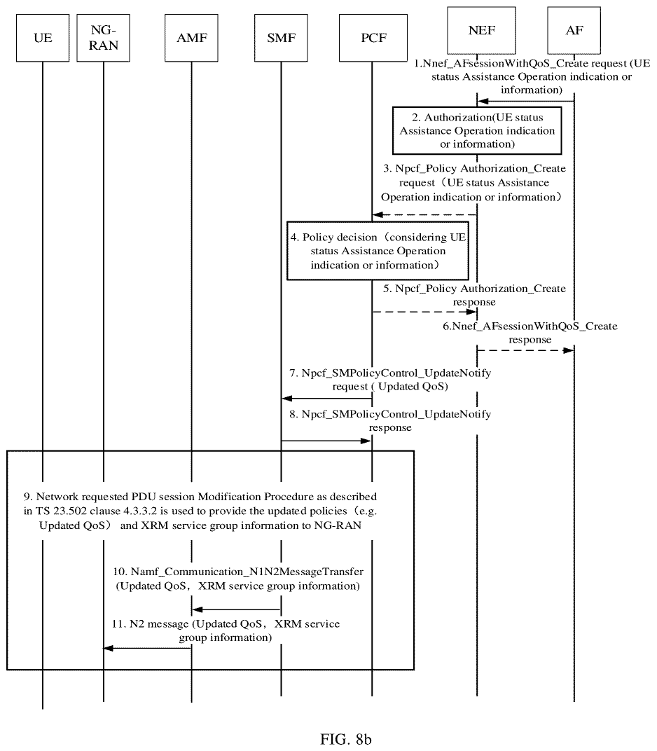

Two embodiments of QoS update and AF request-related traffic will be described below with reference to FIGS. 8a and 8b, respectively.

Embodiment 1 illustrates UE status assistance operation indication or information provided to a PCF via an AF for QoS update.

In this embodiment, with a process of “service specific information provisioning”, the AF sends the UE status assistance operation indication or information obtained from UE to the PCF, so that the PCF can perform corresponding QoS update of XRM service SDF. As illustrated in FIG. 8a, an implementation of this embodiment may include the following steps.

At step 0 (including steps Oa and Ob in FIG. 8a), the UE has registered to a network, and selects the PCF to complete access and mobility management (AM) session association. The PCF, according to subscription information or XRM service policy (or QoS requirement), subscribes to a UDM for a change notice of the UE status assistance operation indication or information, or a change notice of policies or contract information related to XRM service or multimodal data service. Optionally, in a case that the XRM service or XRM service group is associated with a plurality of PCFs, the plurality of PCFs all subscribe to the UDM.

At step 1, the AF triggers an XRM service parameter service (Nnef_XRMServiceParameter service), and establishes an AF request including the UE status assistance operation indication or information.

In this step, the AF obtains the UE status assistance operation indication or information from the UE. The UE may generate the corresponding UE status assistance operation indication or information based on UE status information.

Optionally, the request message includes an XRM service identifier or an XRM service group identifier. The AF provides XRM service or multiple data service specific parameters to a single UE or a plurality of UEs related to the service through Nnef_XRMServiceParameter service. The information sent by the AF includes service description, service parameters, UE or group UE, and subscription to events, which are describe in detail below.

1) Service description: identifies XRM service or XRM data service, which for example, can be identified by a combination of Data Network Name (DNN) and Network Slice Selection Assistance Information (S-NSSAI) or an XRM ID, or represented by an AF-Service-Identifier or an external Application Identifier.

2) Service parameters: information on the AF guidance for XRM service or multimodal data service related Policy and QoS determination, for example, a list of rules that associate XRM service or multiple data service application traffic, UE policy and other parameters, a Group ID, or a combination of DNN and S-NSSAI, a Session and Service Continuity (SSC) mode, a selection priority of corresponding rules (for example, an alternative QoS parameter priority, a corresponding location or time window priority, a corresponding service type or routing selection priority, etc.).

3) The single UE or the group UE related to the XRM service or multiple data Service associated with the AF request.

4) Subscription to events: the AF may subscribe to notifications about execution results and changes of SM policy, AM policy or UE policy.

When the AF needs to update or delete the corresponding request or subscription, an update or deletion procedure of an AF request may also be initiated by this service.

At step 2, the AF sends the AF request to an NEF, the NEF authorizes the AF request and performs relevant mapping, including mapping from external to a core network (CN) identifier. The AF request message carries the UE status assistance operation indication or information.

At step 3, the NEF stores the corresponding request message to the UDR/UDM. The NEF stores the UE status assistance operation indication or information to the UDR/UDM, which can be stored as an association parameter of an access and mobility management function (AMF), an association parameter of a session management function (SMF), or an application data service characteristic parameter.

Optionally, the NEF may improve the corresponding service parameters according to a local configuration. Optionally, based on the operator's policy, the NEF can confirm, for the XRM service or multimodal data service of the single UE or the group UE, whether a service characteristic of the request can be authorized and store the corresponding parameter in the UDR, in combination with the subscription information.

In a case where the group UE is involved, the NEF may transmit the UE status assistance operation indication or information and/or relevant service parameters to the PCF, to perform corresponding authorization, and determination or update of policies and rules in each PCF. The PCF stores corresponding information into the UDR according to an authorization result of the request (the NEF may directly send the UE status assistance operation indication or information and/or the relevant service parameters to a group-related PCF according to a group identifier, or store the UE status assistance operation indication or information and/or the relevant service parameters in the UDM and then send the UE status assistance operation indication or information and/or the relevant service parameters to the group-related PCF through a subscription report).

Optionally, for a group UE scenario, pieces of subscription data of members in the group UE are associated with an XRM service indication or a group ID. Group data of the group UE is consistent (for example, the QoS of the service, and characteristic parameters of access and data routing).

The PCF may subscribe to an XRM service or multimodal data related event trigger through the NEF, such as the UE status assistance operation indication or information, service QoS update, UE relocation, PCF change, etc.

In this step, the PCF obtains the corresponding UE status assistance operation indication or information by receiving a NEF report, and performs subsequent PCC determination or update (for example, coordination of policies such as QoS update, a change of QoS characteristic parameters of UE1 in the XRM service or multimodal data group triggers an event report to the NEF, which is forwarded to corresponding other UEs, or other PCFs associated with the application traffic of the same UE in the XRM service or multimodal data group, to execute the corresponding session update).

At step 4, the NEF returns a create request response message to the AF.

If in step 0, the PCF executes update notification of the UE status assistance operation indication or information or the subscription information after the UE is registered, the subsequent procedure is executed because the AF requests to update subscription information of the UDR/UDM.

At step 5, the PCF receives a change notification of the subscription information of the UDR/UDM.

At step 6, the PCF obtains the UE status assistance operation indication or information, and generates or updates the policy of the corresponding service session or the SDF (for example, XRM service or multimodal data). An implementation of the procedure can be realized in any implementation of the respective embodiments of the disclosure, which is not limited in this embodiment and will not be repeated here.

In this step, in a case where the PCF sends UL and DL Session-AMBR to an SMF according to the UE status assistance operation indication or information, the SMF forwards the UL and DL Session-AMBR to the UPF for execution. If the UPF receives a Session-AMRR value from the SMF, the UL and DL Session-AMBR updated by the PCF should be executed by a User-Defined Function (UDF). Optionally, in a case where the PCF sends a session-AMRR to the UE according to the UE status assistance operation indication or information, the UE performs the updated UL session-AMRR (the UE should perform PDU session based UL rate limitation for non-GBR traffic using the Session-AMRR if the UE receives the Session-AMRR).

In a case where the PCF updates a UE-AMBR, an (R)AN may enforce the UE-AMBR in both UL and DL per UE for non-GBR QoS flows.

In a case where the PCF updates an MFBR, the MFBR is enforced in the UPF in the downlink for GBR QoS flows. The (R)AN executes the updated UL and DL MFBR for the GBR QoS flows.

In a case where the PCF updates a UE-Slice-AMBR, if a RAN (radio access network) receives an updated UE-Slice-MBR, the RAN should apply the updated UE-Slice-MBR for all PDU sessions of the UE corresponding to an S-NSSAI which has an active user plane, if feasible. For example, if a supporting RAN receives for the UE the UE-Slice-MBR for the S-NSSAI from the AMF, the RAN shall apply the UE-Slice-MBR for all PDU sessions of the UE corresponding to the S-NSSAI which has the active user plane (if feasible). Whenever a request for a GBR QoS flow establishment or modification is received, RAN admission control should ensure that a sum of GFBR values of admitted GBR QoS flows does not exceed the UE-Slice-MBR, and if a QoS flow cannot be admitted, the RAN should reject the establishment or modification of the QoS flow. The RAN shall ensure that an aggregated bit rate across all GBR and non-GBR QoS flows belonging to these PDU sessions does not exceed the UE-Slice-MBR, while always guaranteeing the GFBR of each GBR QoS flow of these PDU sessions.

At step 7, if the AF subscribes to an execution notification of XRM service-related policy, the PCF sends a relevant execution result to the AF through the NEF. Meanwhile, in a case where a subscription to the UE status assistance operation indication or information or a subscription to a change of related subscription parameters is present, the PCF updates a change to the UDR and triggers a serving PCF of a UE related to the XRM service group to execute policy change and collaboration. In a case of a multi-PCF scenario, the PCF may directly trigger other PCFs to execute QoS change, or after storing the UE status assistance operation indication or information to the UDM, the PCF triggers a subscription UDM/NEF to report the UE status assistance operation indication or information to the corresponding PCF, and executes acquisition of the UE status assistance operation indication or information of the relevant PCF, or directly changes the policy of the XRM service group.

At step 8, after receiving the notification, the NEF first performs mapping of relevant internal and external parameters, and then reports the relevant UE status assistance operation indication or information to the AF.

Embodiment 2 illustrates a procedure for AF requested correlated traffic and UE status assistance operation indication or information.

In this embodiment, with an AF session setup process, the NEF receives an XRM service-related traffic request including UE status assistance operation indication or information provided by the AF, performs an authorization process of an AF request (i.e., the NEF authorizes or rejects the AF request), and sends an authorization result to the PCF. Based on the received UE status assistance operation indication or information, the PCF generates or updates a PCC rule (e.g., performs QoS update) for service sessions of an XRM service group, or an SDF, or a UE or a group UE executing the XRM service. As illustrated in FIG. 8b, an implementation of this embodiment may include the following steps.

At step 1, the AF sends an AF session resource request, for example, a first create request (Nnef_AFsessionWithQoS_Create request), to create an AF request. The AF carries the UE status assistance operation indication or information in the request message. Optionally, the request message may include XRM service group information, a UE address/UE identifier, an AF identifier application ID, flow description(s), a DNN, an S-NSSAI, QoS parameters and other corresponding information. The group ID can be used to identify all flows in the XRM service group.

At step 2, the AF sends the request to the NEF, and the request message carries the UE status assistance operation indication or information. The NEF authorizes the AF request and performs relevant mapping, including mapping from external to a CN identifier.

At step 3, the NEF authorizes the AF request and decides whether to invoke a TSCTSF or contact the PCF directly according to a parameter provided by the AF. The PCF receives attributes provided by the AF from the NEF or the TSCTSF. The NEF triggers a second create request (NPCF_Policy Authorization_Create Request), and sends the authorized AF request to the PCF, which carries the UE status assistance operation indication or information for policy decision of the PCF. The message carries the XRM service group information. The NEF triggers session update of the corresponding traffic of the XRM service group according to the implementation in step 2.

The NEF stores the corresponding request message to the UDR/UDM. The NEF stores the UE status assistance operation indication or information to the UDR/UDM, which can be stored as an association parameter of an AMF, an association parameter of a SMF, or an application data service characteristic parameter.

In a case where the group UE is involved, the NEF may transmit the UE status assistance operation indication or information and/or relevant service parameters to the PCF, to perform corresponding authorization, and determination or update of policies and rules in each PCF. The PCF stores corresponding information into the UDR according to an authorization result of the request (the NEF may directly send the UE status assistance operation indication or information and/or the relevant service parameters to a group-related PCF according to a group identifier, or store the UE status assistance operation indication or information and/or the relevant service parameters in the UDM and then send the UE status assistance operation indication or information and/or the relevant service parameters to the group-related PCF through a subscription report).

Optionally, for a group UE scenario, pieces of subscription data of members in the group UE are associated with an XRM service indication or a group ID. Group data of the group UE is consistent (for example, the QoS of the service, and characteristic parameters of access and data routing).

The PCF may subscribe to an XRM service or multimodal data related event trigger through the NEF, such as the UE status assistance operation indication or information, service QoS update, UE relocation, PCF change, etc.

In this step, the PCF obtains the corresponding UE status assistance operation indication or information by receiving an NEF report, and then performs subsequent generation or update of a PCC rule (for example, coordination of policies such as QoS update, a change of QoS characteristic parameters of UEL in the XRM service or multimodal data group triggers an event report to the NEF, which is forwarded to corresponding other UEs, or other PCFs associated with the application traffic of the same UE in the XRM service or multimodal data group, to execute the corresponding session update).

At step 4, the PCF makes a policy decision and may determine that updated or new policy information needs to be sent to the SMF.

In this step, the PCF generates or updates the PCC rule based on the UE status assistance operation indication or information provided by the NEF. The PCF triggers a policy control update notification (NPCF_SMPOLICYControl_UPDATE NOTIFY) to update the policy information of the corresponding PDU session of the SMF, including a PCC rule and a QoS policy related to the AF request.

In this step, the PCF obtains the UE status assistance operation indication or information, and generates or updates the policy of the corresponding service session or the SDF (for example, XRM service or multimodal data). An implementation of the procedure can be realized in any implementation of the respective embodiments of the disclosure, which is not limited in this embodiment and will not be repeated here.

In this step, in a case where the PCF sends UL and DL Session-AMBR to an SMF according to the UE status assistance operation indication or information, the SMF forwards the UL and DL Session-AMBR to the UPF for execution. If the UPF receives a Session-AMRR value from the SMF, the UL and DL Session-AMBR updated by the PCF should be enforced by a User-Defined Function (UDF). Optionally, in a case where the PCF sends a session-AMRR to the UE according to the UE status assistance operation indication or information, the UE performs the updated UL session-AMRR (the UE should perform UL rate limitation on PDU session basis for non-GBR traffic using the Session-AMRR if the UE receives the Session-AMRR).

In a case where the PCF updates a UE-AMBR, an (R)AN may enforce the UE-AMBR in both UL and DL per UE for non-GBR QoS flows.

In a case where the PCF updates an MFBR, the MFBR is enforced in the UPF in the downlink for GBR QoS flows. The MFBR is enforced in the (R)AN in uplink and downlink for the GBR QoS flows.

In a case where the PCF updates a UE-Slice-AMBR, if a RAN (radio access network) receives an updated UE-Slice-MBR, the RAN should apply the updated UE-Slice-MBR for all PDU sessions of the UE corresponding to an S-NSSAI which has an active user plane, if feasible. For example, if a supporting RAN receives for the UE the UE-Slice-MBR for the S-NSSAI from the AMF, the RAN shall apply the UE-Slice-MBR for all PDU sessions of the UE corresponding to the S-NSSAI which has the active user plane (if feasible). Whenever a request for a GBR QoS flow establishment or modification is received, RAN admission control should ensure that a sum of GFBR values of admitted GBR QoS flows does not exceed the UE-Slice-MBR, and if a QoS flow cannot be admitted, the RAN should reject the establishment or modification of the QoS flow. The RAN shall ensure that an aggregated bit rate across all GBR and non-GBR QoS flows belonging to these PDU sessions does not exceed the UE-Slice-MBR, while always guaranteeing the GFBR of each GBR QoS flow of these PDU sessions.

At step 5, the PCF sends a response message (Npcf_PolicyAuthorization_Create response message) to the NEF.

At step 6, the NEF sends a response message (Nnef_AFsessionWithQoS_Create response message) to the AF, and the message carries a result, notifying whether the request is authorized.

At step 7, the PCF triggers an update notification (Npcf_SMPolicyControl_UpdateNotify) operation and provides possibly updated policy information about the PDU session to the SMF. This update includes the attributes provided by the AF in step 1 and mapped to a specific PDU session by the PCF.

Optionally, the UL and DL Session-AMBR is sent to the SMF, and then forwarded to the UPF for execution. If the UPF receives the session-AMRR value from the SMF, the UL and DL session-AMRR updated by the PCF should be executed by the UDF.

In a case where the PCF updates an MFBR, the MFBR is enforced in the UPF in the downlink for GBR QoS flows.

At step 8, the SMF confirms a PCF request using a response (Npcf_SMPolicyControl_UpdateNotify).

At steps 9-11, the SMF determines an authorized QoS of the QoS flow using the PCC rule received in step 8, and initiates a network requested PDU session modification procedure as described in the related art to provide updated QoS and XRM service group information for the correlated traffic flows to the NG-RAN (via the AMF). After receiving the information, the NG-RAN will apply the information across the traffic flows.

Optionally, in a case where the session-AMBR is sent to the UE, the UE performs the updated UL session-AMRR (the UE should perform UL rate limitation on PDU session basis for non-GBR traffic using the Session-AMRR if the UE receives the Session-AMRR).

In a case where the PCF updates a UE-AMBR, an (R)AN may enforce the UE-AMBR in both UL and DL per UE for non-GBR QoS flows.

In a case where the PCF updates the MFBR, The (R)AN executes the updated UL and DL MFBR for the GBR QoS flows (the MFBR is enforced in the (R)AN in the downlink and uplink for GBR QoS flows.

In a case where the PCF updates a UE-Slice-AMBR, if a RAN (radio access network) receives an updated UE-Slice-MBR, the RAN should apply the updated UE-Slice-MBR for all PDU sessions of the UE corresponding to an S-NSSAI which has an active user plane, if feasible. For example, if a supporting RAN receives for the UE the UE-Slice-MBR for the S-NSSAI from the AMF, the RAN shall apply the UE-Slice-MBR for all PDU sessions of the UE corresponding to the S-NSSAI which has the active user plane (if feasible). Whenever a request for a GBR QoS flow establishment or modification is received, RAN admission control should ensure that a sum of GFBR values of admitted GBR QoS flows does not exceed the UE-Slice-MBR, and if a QoS flow cannot be admitted, the RAN should reject the establishment or modification of the QoS flow. The RAN shall ensure that an aggregated bit rate across all GBR and non-GBR QoS flows belonging to these PDU sessions does not exceed the UE-Slice-MBR, while always guaranteeing the GFBR of each GBR QoS flow of these PDU sessions.

By implementing embodiments of the disclosure, the UE status assistance operation indication or information is provided to the network (e.g., the PCF) for supporting tradeoff between throughput/latency/reliability and power consumption (e.g., policy determination and enforcement can be made based on the UE status assistance operation indication or information). The provided UE status assistance operation indication or information is used as additional information for policy determination to reduce usage of network resources of the radio interface, especially when there is limited resources. In addition, the disclosure can enables the usage of the network resources based on a UE capability (e.g., the UE status assistance operation indication or information). The disclosure improves user experience by allowing the usage of the applications critical to a user in a power-saving mode while prolonging a battery life instead of completely switching the battery off.

In the above embodiments of the disclosure, the methods provided by the embodiments of the disclosure are introduced from perspectives of the PCF, the AF and the UE, respectively. In order to realize the functions in the methods provided by the embodiments of the disclosure, the PCF, the AF or the UE may include a hardware structure and a software module, and realize the above functions in the form of the hardware structure, the software module, or a combination of the hardware structure and the software module. One of the above functions can be implemented in the form of the hardware structure, the software module, or the combination of the hardware structure and the software module.

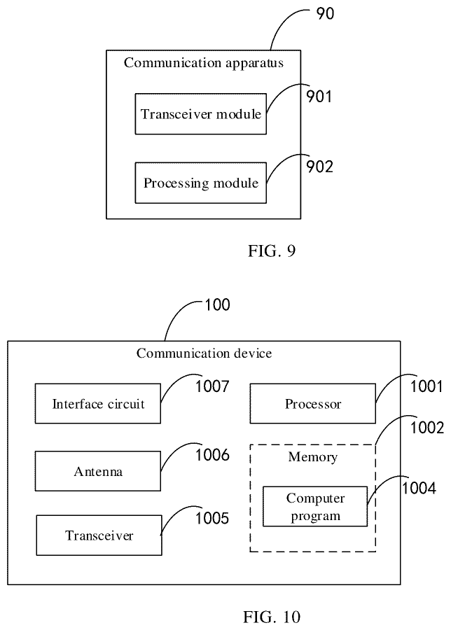

FIG. 9 is a schematic diagram of a communication apparatus 90 provided by an embodiment of the disclosure. The communication apparatus 90 shown in FIG. 9 may include a transceiver module 901 and a processing module 902. The transceiver module 901 may include a sending module and/or a receiving module. The sending module is used for realizing a sending function, and the receiving module is used for realizing a receiving function. The transceiver module 901 may realize the sending function and/or the receiving function.

The communication apparatus 90 may be a PCF, a device in the PCF, or a device that can be used together with the PCF. Or, the communication apparatus 90 may be an AF, a device in the AF, or a device that can be used together with the AF. Or, the communication apparatus 90 may be a UE, a device in the UE, or a device that can be used together with the UE.

If the communication apparatus 90 is a PCF, the processing module 902 is configured to obtain UE status assistance operation indication or information of a UE from an AF, and generate or update a policy of a service session or a SDF of the UE in combination with the UE status assistance operation indication or information.

In a possible implementation, the processing module 902 is further configured to: obtain the UE status assistance operation indication or information directly from the AF.

In another possible implementation, the processing module 902 is further configured to: obtain the UE status assistance operation indication or information from the AF through a NEF.

In another possible implementation, the processing module 902 is further configured to: obtain the UE status assistance operation indication or information from the AF through a TSCTSF, or obtain the UE status assistance operation indication or information from the AF through the TSCTSF and a NEF.

In an implementation, the processing module 902 is further configured to: generate or update a PCC rule.

In a possible implementation, the processing module 902 is further configured to: update a QoS parameter of the service session or the SDF of the UE.

In a possible implementation, the QoS parameter includes at least one of: an uplink GBR traffic bit rate; a downlink GBR traffic bit rate; an uplink non-GBR traffic bit rate; a downlink non-GBR traffic bit rate; a maximum RTT; or a maximum packet loss rate.

In a possible implementation, the processing module 902 is further configured to: make a decision on whether to perform PDU set-based QoS handling; and/or, make a decision on whether to select different QoS profiles for different QoS levels based on first information of a PDU set or a PDU set group, in which the first information includes at least one of a priority, an importance or a dependency.

In a possible implementation, the method is applicable for a multi-PCF scenario, the processing module 902 is further configured to: trigger other PCFs in the multi-PCF scenario to perform QoS change; or, after storing the UE status assistance operation indication or information in a UDM or a UDR, trigger a subscription to one of the UDM, the UDR and a NEF to send the UE status assistance operation indication or information to a corresponding PCF.

In an implementation, the UE status assistance operation indication or information includes at least one of: a UE status assistance operation mode; a UE status assistance operation mode indicator; a threshold value; a UE status assistance operation functionality; a priority; or an importance.

In a possible implementation, the UE status assistance operation mode is applied for matching traffic and associated parameters.

In a possible implementation, the UE status assistance operation mode indicator is indication information indicating autonomous operation or UE-assistance operation when the UE status assistance operation mode is set to a first mode, in which the first mode is any one of: load balancing; power consumption; and PDU set based QoS handling.

In a possible implementation, the threshold value includes at least one of: a maximum RTT; a maximum packet loss rate; a GFBR; or an AMBR.

In a possible implementation, the UE status assistance operation functionality indicates that a first functionality is applied for matching traffic, in which the first functionality includes any one of a load balancing functionality, a power consumption functionality and a PDU set based QoS handling functionality.

In a possible implementation, the priority indicates a priority level of QoS applied for matching traffic.

In a possible implementation, the importance indicates an importance level of QoS applied for matching traffic.

If the communication apparatus 90 is an AF, the transceiver module 901 is configured to: send UE status assistance operation indication or information of a UE to a PCF, in which the UE status assistance operation indication or information is used to assist the PCF to generate or update a policy of a service session or a SDF of the UE.

In an implementation, the processing module 902 is further configured to: obtain the UE status assistance operation indication or information from the UE after the UE is registered to a network.

In an implementation, the transceiver module 901 is configured to: send the UE status assistance operation indication or information directly to the PCF.

In an implementation, the transceiver module 901 is configured to: send the UE status assistance operation indication or information to the PCF through a NEF.

In an implementation, the transceiver module 901 is configured to: send the UE status assistance operation indication or information to the PCF through a TSCTSF, or send the UE status assistance operation indication or information to the PCF through the TSCTSF and a NEF.

In an implementation, the UE status assistance operation indication or information includes at least one of: a UE status assistance operation mode; a UE status assistance operation mode indicator; a threshold value; a UE status assistance operation functionality; a priority; or an importance.

In a possible implementation, the UE status assistance operation mode is applied for matching traffic and associated parameters.

In a possible implementation, the UE status assistance operation mode indicator is indication information indicating autonomous operation or UE-assistance operation when the UE status assistance operation mode is set to a first mode, in which the first mode is any one of: load balancing; power consumption; and PDU set based QoS handling.

In a possible implementation, the threshold value includes at least one of: a maximum RTT; a maximum packet loss rate; a GFBR; or an AMBR.

In a possible implementation, the UE status assistance operation functionality indicates that a first functionality is applied for matching traffic, in which the first functionality includes any one of a load balancing functionality, a power consumption functionality and a PDU set based QoS handling functionality.

In a possible implementation, the priority indicates a priority level of QoS applied for matching traffic.

In a possible implementation, the importance indicates an importance level of QoS applied for matching traffic.

If the communication apparatus 90 is a UE, the transceiver module 901 is configured to: send UE status assistance operation indication or information of the UE to an AF, in which the UE status assistance operation indication or information is used to assist a PCF to generate or update a policy of a service session or a SDF of the UE.

In an implementation, the processing module 902 is configured to: generate the UE status assistance operation indication or information based on UE status information of the UE.

In an implementation, the UE status information includes at least one of: a battery level; a battery life; a powered mode; an overheating status; or a load status.

In an implementation, the UE status assistance operation indication or information includes at least one of: a UE status assistance operation mode; a UE status assistance operation mode indicator; a threshold value; a UE status assistance operation functionality; a priority; or an importance.

In a possible implementation, the UE status assistance operation mode is applied for matching traffic and associated parameters.

In a possible implementation, the UE status assistance operation mode indicator is indication information indicating autonomous operation or UE-assistance operation when the UE status assistance operation mode is set to a first mode, in which the first mode is any one of: load balancing; power consumption; and PDU set based QoS handling.

In a possible implementation, the threshold value includes at least one of: a maximum RTT; a maximum packet loss rate; a GFBR; or an AMBR.

In a possible implementation, the UE status assistance operation functionality indicates that a first functionality is applied for matching traffic, in which the first functionality includes any one of a load balancing functionality, a power consumption functionality and a PDU set based QoS handling functionality.

In a possible implementation, the priority indicates a priority level of QoS applied for matching traffic.

In a possible implementation, the importance indicates an importance level of QoS applied for matching traffic.

With regard to the apparatus in the above embodiments, the specific way in which each module performs operations has been described in detail in the method embodiments, and will not be described in detail here.

The embodiment of the disclosure also provides a communication device, which can be applied to a core network. The core network includes an AF and a PCF. The AF is configured to receive the UE status assistance operation indication or information sent by the UE. The PCF is configured to obtain the UE status assistance operation indication or information from the AF, and generate or update the policy of the service session or the SDF of the UE in combination with the UE status assistance operation indication or information. With regard to the apparatus in the above embodiments, the specific way in which each module performs operations has been described in detail in the method embodiments, and will not be described in detail here.

FIG. 10 is a schematic diagram of a communication device 100 provided by an embodiment of the disclosure. The communication device 100 may be a PCF, an AF or a UE, or a chip, a chip system or a processor that supports the PCF to realize the above-described methods, or a chip, a chip system or a processor that supports the AF to realize the above-described methods, or a chip, a chip system or a processor that supports the UE to realize the above-described methods. The device may be used to realize the methods described in the above method embodiments with reference to the descriptions of the above-described method embodiments.

The communication device 100 may include one or more processors 1001. The processor 1001 may be a general purpose processor or a dedicated processor, such as, a baseband processor or a central processor. The baseband processor is used for processing communication protocols and communication data. The central processor is used for controlling the communication device (e.g., base station, baseband chip, UE, UE chip, central unit (CU) or distributed unit (DU)), executing computer programs, and processing data of the computer programs.

Optionally, the communication device 100 may further include one or more memories 1002 on which a computer program 1004 may be stored. When the processor 1001 executes the computer program 1004, the communication device 100 is caused to perform the methods described in the above method embodiments. Optionally, data may also be stored in the memory 1002. The communication device 100 and the memory 1002 may be provided separately or may be integrated together.

Optionally, the communication device 100 may also include a transceiver 1005 and an antenna 1006. The transceiver 1005 may be referred to as transceiver unit, transceiver machine, or transceiver circuit, for realizing the transceiver function. The transceiver 1005 may include a receiver and a transmitter. The receiver may be referred to as receiver machine or receiving circuit, for realizing the receiving function. The transmitter may be referred to as transmitter machine or transmitting circuit, for realizing the transmitting function.

Optionally, the communication device 100 may also include one or more interface circuits 1007. The interface circuits 1007 are used to receive code instructions and transmit them to the processor 1001. The processor 1001 runs the code instructions to cause the communication device 100 to perform the methods described in the method embodiments.

If the communication device 100 is a PCF, the processor 1001 is used to execute steps 101 and 102 in FIG. 1, or steps 201 and 202 in FIG. 2.

If the communication device 100 is an AF, the transceiver 1005 is used to perform step 301 in FIG. 3 or step 402 in FIG. 4, and the processor 1001 is used to perform step 401 in FIG. 4.

If the communication device 100 is a UE, the transceiver 1005 is used to perform step 501 in FIG. 5 or step 602 in FIG. 6, and the processor 1001 is used to perform step 601 in FIG. 6.

In an implementation, the processor 1001 may include a transceiver for implementing the receiving and transmitting functions. The transceiver may be, for example, a transceiver circuit, an interface, or an interface circuit. The transceiver circuit, interface, or interface circuit for implementing the receiving and transmitting functions may be separated or may be integrated together. The transceiver circuit, interface, or interface circuit described above may be used for code/data reading and writing, or may be used for signal transmission or delivery.

In an implementation, the processor 1001 may store a computer program that can be executed by the processor 1001 and may cause the communication device 100 to perform the methods described in the method embodiments above. The computer program may be solidified in the processor 1001, in which case the processor 1001 may be implemented by hardware.

In an implementation, the communication device 100 may include circuits. The circuits may implement the sending, receiving or communicating function in the preceding method embodiments. The processor and the transceiver described in this disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and the transceiver can also be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication device in the descriptions of the above embodiments may be a PCF, an AF or a UE, but the scope of the communication device described in the disclosure is not limited thereto, and the structure of the communication device may not be limited by FIG. 10. The communication device may be a stand-alone device or may be part of a larger device. For example, the described communication device may be:
(1) a stand-alone IC, chip, chip system or subsystem;
(2) a collection of ICs including one or more ICs, optionally, the collection of ICs may also include storage components for storing data and computer programs;
(3) an ASIC, such as a modem;
(4) modules that can be embedded within other devices;
(5) receivers, UEs, smart UEs, cellular phones, wireless devices, handheld machines, mobile units, in-vehicle devices, network devices, cloud devices, artificial intelligence devices, and the like; and
(6) others.

It is understandable by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be construed as being beyond the scope of protection of the embodiments of the disclosure.

The embodiment of the disclosure also provides a core network system, which may include a PCF, an AF and a UE. The PCF is configured to execute the method described in any one of the aforementioned embodiments in FIG. 1 and FIG. 2. The AF is configured to perform the method described in any one of the aforementioned embodiments in FIG. 3 and FIG. 4. The UE is configured to perform the method as described in any of the aforementioned embodiments in FIG. 5 or FIG. 6.

The embodiment of the disclosure also provides a UE policy update system, which includes the communication devices as the PCF, the AF and the UE in the embodiment of FIG. 9. Or, the system includes the communication devices as the PCF, the AF and the UE in the embodiment of FIG. 10.

The disclosure also provides a readable storage medium having an instruction stored thereon. When the instruction is executed by a computer, the function of any of the method embodiments described above is implemented.

The disclosure also provides a computer program product. When the computer program product is executed by a computer, the function of any of the method embodiments described above is implemented.

The above embodiments may be implemented in whole or in part by software, hardware, firmware, or any combination thereof. When implemented using software, it may be implemented, in whole or in part, in the form of a computer program product. The computer program product includes one or more computer programs. When loading and executing the computer program on the computer, all or part of processes or functions described in the embodiments of the disclosure are implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., by using coaxial cables, fiber optics, or digital subscriber lines (DSLs) or wirelessly (e.g., by using infrared wave, wireless wave, or microwave). The computer-readable storage medium may be any usable medium to which the computer has access or a data storage device integrated by one or more usable mediums such as a server and a data center. The usable medium may be a magnetic medium (e.g., floppy disk, hard disk, and tape), an optical medium (e.g., a high-density digital video disc (DVD)), or a semiconductor medium (e.g., a solid state disk (SSD)).

Those skilled in the art understand that “first”, “second”, and other various numerical numbers involved in the disclosure are only described for the convenience of differentiation, and are not used to limit the scope of the embodiments of the disclosure, or indicate the order of precedence.

The term “at least one” in the disclosure may also be described as one or more, and the term “multiple” may be two, three, four, or more, which is not limited in the disclosure. In the embodiment of the disclosure, for a type of technical features, “first”, “second”, and “third”, and “A”, “B”, “C” and “D” are used to distinguish different technical features of the type, the technical features described using the “first”, “second”, and “third”, and “A”, “B”, “C” and “D” do not indicate any order of precedence or magnitude.

The correspondences shown in the tables in this disclosure may be configured or may be predefined. The values of information in the tables are merely examples and may be configured to other values, which are not limited by the disclosure. In configuring the correspondence between the information and the parameter, it is not necessarily required that all the correspondences illustrated in the tables must be configured. For example, the correspondences illustrated in certain rows in the tables in this disclosure may not be configured. For another example, the above tables may be adjusted appropriately, such as splitting, combining, and the like. The names of the parameters shown in the titles of the above tables may be other names that may be understood by the communication device, and the values or representations of the parameters may be other values or representations that may be understood by the communication device. Each of the above tables may also be implemented with other data structures, such as, arrays, queues, containers, stacks, linear tables, pointers, chained lists, trees, graphs, structures, classes, heaps, and Hash tables.

The term “predefine” in this disclosure may be understood as define, pre-define, store, pre-store, pre-negotiate, pre-configure, solidify, or pre-fire.

Those skilled in the art may realize that the units and algorithmic steps of the various examples described in combination with the embodiments disclosed herein are capable of being implemented in the form of electronic hardware, or a combination of computer software and electronic hardware. Whether these functions are performed in the form of hardware or software depends on the specific application and design constraints of the technical solution. Those skilled in the art may use different methods to implement the described functions for each particular application, but such implementations should not be considered as beyond the scope of the disclosure.

It is clearly understood by those skilled in the field to which it belongs that, for the convenience and brevity of description, the specific working processes of the systems, apparatuses, and units described above may be referred to the corresponding processes in the preceding method embodiments, and will not be repeated herein.

It should also be noted that any process or method description in the flowchart or otherwise described herein can be understood as representing a module, a segment or a part of code that includes one or more executable instructions for implementing customized logic functions or steps of the process. The scope of the preferred embodiments of the disclosure includes other implementations, in which functions can be performed out of the order shown or discussed, including in a substantially simultaneous manner or in a reverse order according to the functions involved, which should be understood by those skilled in the technical field to which the embodiments of the disclosure belong.

The above are only specific implementations of the disclosure, but the scope of protection of the disclosure is not limited thereto. Those skilled in the art familiar to this technical field may easily think of changes or substitutions in the technical scope disclosed by the disclosure, which shall be covered by the scope of protection of the disclosure. Therefore, the scope of protection of the disclosure shall be governed by the scope of protection of the attached claims.

1. A method for user equipment (UE) policy update, performed by a policy control function (PCF), comprising:
obtaining UE status assistance operation indication or information of a UE from an application function (AF); and
generating or updating a policy of a service session or a service data flow of the UE in combination with the UE status assistance operation indication or information.

2. The method of claim 1, wherein obtaining the UE status assistance operation indication or information of the UE from the AF comprises at least one of:
obtaining the UE status assistance operation indication or information directly from the AF;
obtaining the UE status assistance operation indication or information from the AF through a network exposure function (NEF);
obtaining the UE status assistance operation indication or information from the AF through a time-sensitive communication time synchronization function (TSCTSF);
or,
obtaining the UE status assistance operation indication or information from the AF through the TSCTSF and a NEF.

3. (canceled)

4. (canceled)

5. The method of claim 1, wherein generating or updating the policy of the service session or the service data flow of the UE comprises:
generating or updating a policy and charging control (PCC) rule.

6. The method of claim 5, wherein generating or updating the PCC rule comprises:
updating a quality of service (QoS) parameter of the service session or the service data flow of the UE;
or generating or updating the PCC rule comprises at least one of:
making a decision on whether to perform packet data unit (PDU) set-based QoS handling; or
making a decision on whether to select different QoS profiles for different QoS levels based on first information of a PDU set or a PDU set group, wherein the first information comprises at least one of a priority, an importance or a dependency.

7. The method of claim 6, wherein the QoS parameter comprises at least one of:
an uplink guaranteed bit rate (GBR) traffic bit rate;
a downlink GBR traffic bit rate;
an uplink non-GBR traffic bit rate;
a downlink non-GBR traffic bit rate;
a maximum round trip time; or
a maximum packet loss rate.

8. (canceled)

9. The method of claim 1, wherein the method is applicable for a multi-PCF scenario, and the method further comprises:
triggering other PCFs in the multi-PCF scenario to perform QoS change;
or,
after storing the UE status assistance operation indication or information in a unified data management (UDM) or a user data repository (UDR), triggering a subscription to one of the UDM, the UDR and a NEF to send the UE status assistance operation indication or information to a corresponding PCF.

10. The method of claim 1, wherein the UE status assistance operation indication or information comprises at least one of:
a UE status assistance operation mode;
a UE status assistance operation mode indicator;
a threshold value;
a UE status assistance operation functionality;
a priority; or
an importance.

11. The method of claim 10, wherein
the UE status assistance operation mode is applied for matching traffic and associated parameters; or
the UE status assistance operation mode indicator is indication information indicating autonomous operation or UE-assistance operation when the UE status assistance operation mode is set to a first mode, wherein the first mode is any one of:
load balancing;
power consumption; and
PDU set based QoS handling; or
the threshold value comprises at least one of:
a maximum round trip time;
a maximum packet loss rate;
a guaranteed flow bit rate (GFBR); or
an aggregated maximum bit rate (AMBR); or
the UE status assistance operation functionality indicates that a first functionality is applied for matching traffic, wherein the first functionality comprises any one of a load balancing functionality, a power consumption functionality and a PDU set based QoS handling functionality; or
the priority indicates a priority level of QoS applied for matching traffic; or
the importance indicates an importance level of QoS applied for matching traffic.

12.-16. (canceled)

17. A method for user equipment (UE) policy update, performed by an application function (AF), comprising:
sending UE status assistance operation indication or information of a UE to a policy control function (PCF);
wherein the UE status assistance operation indication or information is used to assist the PCF to generate or update a policy of a service session or a service data flow of the UE.

18. The method of claim 17, further comprising:
obtaining the UE status assistance operation indication or information from the UE after the UE is registered to a network.

19. The method of claim 17, wherein sending the UE status assistance operation indication or information of the UE to the PCF comprises at least one of:
sending the UE status assistance operation indication or information directly to the PCF;
sending the UE status assistance operation indication or information to the PCF through a network exposure function (NEF);
sending the UE status assistance operation indication or information to the PCF through a time-sensitive communication time synchronization function (TSCTSF); or
sending the UE status assistance operation indication or information to the PCF through the TSCTSF and a NEF.

20. (canceled)

21. (canceled)

22. The method of claim 17, wherein the UE status assistance operation indication or information comprises at least one of:
a UE status assistance operation mode;
a UE status assistance operation mode indicator;
a threshold value;
a UE status assistance operation functionality;
a priority; or
an importance.

23. The method of claim 22, wherein
the UE status assistance operation mode is applied for matching traffic and associated parameters; or
wherein the UE status assistance operation mode indicator is indication information indicating autonomous operation or UE-assistance operation when the UE status assistance operation mode is set to a first mode, wherein the first mode is any one of:
load balancing;
power consumption; and
PDU set based QoS handling; or
the threshold value comprises at least one of:
a maximum round trip time;
a maximum packet loss rate;
a guaranteed flow bit rate (GFBR); or
an aggregated maximum bit rate (AMBR); or
wherein the UE status assistance operation functionality indicates that a first functionality is applied for matching traffic, wherein the first functionality comprises any one of a load balancing functionality, a power consumption functionality and a PDU set based QoS handling functionality; or
the priority indicates a priority level of QoS applied for matching traffic; or
the importance indicates an importance level of QoS applied for matching traffic.

24.-28. (canceled)

29. A method for user equipment (UE) policy update, performed by a UE, comprising:
sending UE status assistance operation indication or information of the UE to an application function (AF);
wherein the UE status assistance operation indication or information is used to assist a policy control function (PCF) to generate or update a policy of a service session or a service data flow of the UE.

30. The method of claim 29, further comprising:
generating the UE status assistance operation indication or information based on UE status information of the UE.

31. (canceled)

32. The method of claim 29, wherein the UE status assistance operation indication or information comprises at least one of:
a UE status assistance operation mode;
a UE status assistance operation mode indicator;
a threshold value;
a UE status assistance operation functionality;
a priority; or
an importance.

33. The method of claim 32, wherein
the UE status assistance operation mode is applied for matching traffic and associated parameters; or
the UE status assistance operation mode indicator is indication information indicating autonomous operation or UE-assistance operation when the UE status assistance operation mode is set to a first mode, wherein the first mode is any one of: load balancing; power consumption; and PDU set based QoS handling; or
the threshold value comprises at least one of: a maximum round trip time; a maximum packet loss rate; a guaranteed flow bit rate (GFBR); or an aggregated maximum bit rate (AMBR); or
the UE status assistance operation functionality indicates that a first functionality is applied for matching traffic, wherein the first functionality comprises any one of a load balancing functionality, a power consumption functionality and a PDU set based QoS handling functionality; or
the priority indicates a priority level of QoS applied for matching traffic; or
the importance indicates an importance level of QoS applied for matching traffic.

34.-53. (canceled)

54. A communication apparatus, comprising a processor and a memory, wherein the memory stores a computer program, and the processor executes the computer program stored in the memory to cause the device to implement the method claim 1.

55. A communication apparatus, comprising a processor and a memory, wherein the memory stores a computer program, and the processor executes the computer program stored in the memory to cause the device to implement the method claim 17.

56. A communication apparatus, comprising a processor and a memory, wherein the memory stores a computer program, and the processor executes the computer program stored in the memory to cause the device to implement the method claim 29.

57.-59. (canceled)
